(19) United States
(12) Patent Application Publication
(10) Pub. No.: US 2009/0154137 A1
(43) Pub. Date: Jun. 18, 2009

(54) Illumination Device Including Collimating Optics

(75) Inventors: Serge J. Bierhuizen, Santa Rosa, CA (US); Gerard Harbers, Sunnyvale, CA (US)

Correspondence Address: PATENT LAW GROUP LLP, 2635 NORTH FIRST STREET, SUITE 223, SAN JOSE, CA, 95134, US

(73) Assignee: PHILIPS LUMILEDS LIGHTING COMPANY, LLC, San Jose, CA (US)

(21) Appl. No.: 11/956,992

(22) Filed: Dec. 14, 2007

(51) Int. Cl. F21V 9/16; F21V 9/00

(52) U.S. Cl. 362/84; 362/293

(57) ABSTRACT

A structure for providing a collimated light beam includes a light source configured to emit light having a first peak wavelength combined with a group of structures configured to direct at least a portion of light exiting the light source in a direction substantially perpendicular to a top surface of the light source and reflect another portion. In some embodiments, a wavelength converting element is positioned in a path of light emitted from the light source, the wavelength converting element configured to absorb at least a portion of the light having a first peak wavelength and emit light having a second peak wavelength. The group of structures may be formed over the wavelength converting element, such that the wavelength converting element is disposed between the group of structures and the light source.

### BACKGROUND

1. Field of Invention

The present invention is related to an illumination device and, in particular, to a semiconductor light emitting device including optics configured to direct at least a portion of light exiting the device in a direction substantially perpendicular to a top surface of the semiconductor structure.

2. Description of Related Art

Semiconductor light-emitting devices including light emitting diodes (LEDs), resonant cavity light emitting diodes (RCLEDs), vertical cavity laser diodes (VCSELs), and edge emitting lasers are among the most efficient light sources currently available. Materials systems currently of interest in the manufacture of high-brightness light emitting devices capable of operation across the visible spectrum include Group III-V semiconductors, particularly binary, ternary, and quaternary alloys of gallium, aluminum, indium, and nitrogen, also referred to as III-nitride materials. Typically, semiconductor LEDs are fabricated by epitaxially growing a stack of semiconductor layers of different compositions and dopant concentrations on a substrate. The stack often includes one or more n-type layers formed over the substrate, one or more light emitting layers in an active region formed over the n-type layer or layers, and one or more p-type layers formed over the active region. Electrical contacts are formed on the n- and p-type regions.

The light emitted by current commercially available III-nitride devices is generally on the shorter wavelength end of the visible spectrum; thus, the light generated by III-nitride devices can be readily converted to produce light having a longer wavelength. It is well known in the art that light having a first peak wavelength (the “primary light”) can be converted into light having one or more longer peak wavelengths (the “secondary light”) using a process known as luminescence/fluorescence. The fluorescent process involves absorbing the primary light by a wavelength-converting material such as a phosphor and exciting the luminescent centers of the phosphor material, which emit the secondary light. The peak wavelength of the secondary light will depend on the phosphor material. The type of phosphor material can be chosen to yield secondary light having a particular peak wavelength. LEDs may use phosphor conversion of the primary emission to generate white light. Phosphors can also be used to create more saturated colors like red, green, and yellow.

Some lighting applications operate more efficiently when the light source emits a collimated light beam.

### SUMMARY

In accordance with embodiments of the invention, a light source configured to emit light having a first peak wavelength is combined with a group of structures configured to direct at least a portion of light exiting the light source in a direction substantially perpendicular to a top surface of the light source. In some embodiments, a wavelength converting element is positioned in a path of light emitted from the light source, the wavelength converting element configured to absorb at least a portion of the light having a first peak wavelength and emit light having a second peak wavelength. The group of structures may be formed over the wavelength converting element, such that the wavelength converting element is disposed between the group of structures and the light source.

In some embodiments, the wavelength converting element is supported by a heat sink, such that the wavelength converting element is not in direct contact with the light source. For example, the heat sink may hold the wavelength converting element by at least one side of the wavelength converting element such that neither an input area of the wavelength converting element that receives the emitted light from the light source, nor an output area of the wavelength converting element from which the light having a second wavelength range is emitted by the wavelength converting element, is supported by the heat sink.

### BRIEF DESCRIPTION OF THE DRAWINGS

FIG. 1 illustrates an illumination device.

FIG. 2 is a flow diagram schematically showing the preparation of a luminescent ceramic.

FIG. 3 illustrates the transmission characteristics of one suitable embodiment of a dichroic filter coating as a function of wavelength for different angles of incidence.

FIG. 4 illustrates the performance of one suitable embodiment of the dichroic filter coating with regard to the transmission of the blue pump light as a function of wavelength for a Lambertian source.

FIG. 5 illustrates the transmission characteristics of one suitable embodiment of a second dichroic filter coating as a function of wavelength as an average of the different angles of incidence.

FIG. 6 illustrates an embodiment of a wavelength converting element with a roughened surface.

FIG. 7 is a cross sectional view of collimating optics formed on a wavelength converting element.

FIG. 8 is a view of round collimating optics at a plane where the collimating optics attach to a wavelength converting element.

FIG. 9 is a cross sectional view of a collimating optic.

FIG. 10 is a view of hexagonal collimating optics at a plane where the collimating optics attach to a surface.

FIG. 11 is a view of hexagonal collimating optics at a plane where light exits the collimating optics.

### DETAILED DESCRIPTION

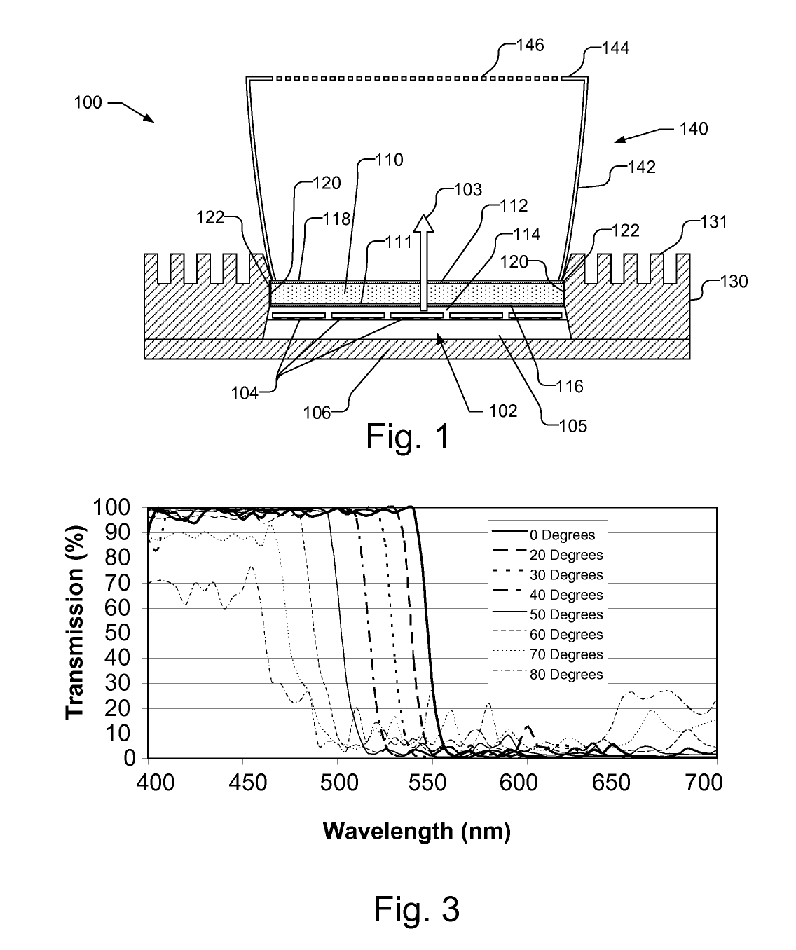

FIG. 1 illustrates an illumination device 100 described in more detail in “Illumination Device with Wavelength Converting Element Side Holding Heat Sink,” application Ser. No. 11/463,443, filed Aug. 9, 2006, and incorporated herein by reference. FIG. 1 includes a light source 102, which may be, for example, a semiconductor light emitting device, such as a light emitting diode (LED) or an array of LEDs 104, or other types of light sources that can produce short wavelength light, such as a xenon lamp or mercury lamp. By way of example, the LEDs 104 are blue or ultraviolet (UV) LEDs and may be high radiance devices, such as the type described in “Package for a Semiconductor Light Emitting Device”, application Ser. No. 10/652,348, filed Aug. 29, 2003, Publication Number 2005/0045901, which is incorporated herein by reference, or described in “Light Emitting Diode Array,” application Ser. No. 11/844,279, filed Aug. 23, 2007, which is also incorporated herein by reference. The angular emission pattern of the LEDs 104 can be Lambertian or controlled using a structure such as a photonic crystal. The light emitting diodes 104 are shown mounted on a heatsink 106. In some embodiments, the light emitting diodes 104 may be mounted on a mount 105, which is mounted to the heatsink 106.

Illumination device 100 includes a wavelength converting element 110 that is physically separated from the light source 102 along the optical path (generally illustrated by arrow 103). The input side 111 of the wavelength converting element 110 is, in this example, not in direct contact with the light source 102. The light source 102 and the wavelength converting element 110 may be separated by a medium 114, such as air, gas, silicone or a vacuum. Thus, light emitted by the light source 102 must travel through the medium 114 before the light is received at the input side 111 of the wavelength converting element 110. The length of the physical separation between the light source 102 and the wavelength converting element 110 may vary, but in one embodiment is in the range of 50 μm-250 μm. In one embodiment, the physical separation between the light source 102 and the wavelength converting element 110 is sufficient to prevent substantial conductive heating of the wavelength converting element 110 by the light source 102. In another embodiment, a filler or bonding material may be used to separate the light source 102 from the wavelength converting element 110.

The wavelength converting element 110 may be formed from a ceramic slab, sometimes referred to herein as a “luminescent ceramic”. The ceramic slabs are generally self-supporting layers and may be translucent or transparent to particular wavelengths, which may reduce the scattering loss associated with non-transparent wavelength converting layers such as conformal layers. Luminescent ceramic layers may be more robust than thin film or conformal phosphor layers. In some embodiments, materials other than luminescent ceramics may be used as the wavelength converting element 110, such as phosphors in a binder material.

A luminescent ceramic may be formed by heating a powder phosphor at high pressure until the surface of the phosphor particles begin to sinter together to form a rigid agglomerate of particles. Unlike a thin film, which optically behaves as a single, large phosphor particle with no optical discontinuities, a luminescent ceramic behaves as tightly packed individual phosphor particles, such that there are small optical discontinuities at the interface between different phosphor particles. Thus, luminescent ceramics are optically almost homogenous and have the same refractive index as the phosphor material forming the luminescent ceramic. Unlike a conformal phosphor layer or a phosphor layer disposed in a transparent material such as a resin, a luminescent ceramic generally requires no binder material (such as an organic resin or epoxy) other than the phosphor itself, such that there is very little space or material of a different refractive index between the individual phosphor particles. As a result, a luminescent ceramic is transparent or translucent, unlike a conformal phosphor layer. Luminescent ceramics that may be used with the present invention are described in more detail in “Luminescent Ceramic for a Light Emitting Device,” application Ser. No. 10/861,172, filed Jun. 3, 2004, Publication Number 2005/0269582, which is incorporated herein by reference.

Examples of phosphors that may be formed into luminescent ceramic layers include aluminum garnet phosphors with the general formula (Lu_{1-x-y-a-b}YₓGd_{y})₃(Al_{1-z}Ga_{z})₅O₁₂:CeₐPr_{b} wherein 0<x<1, 0<y<1, 0<z≦0.1, 0<a≦0.2 and 0<b≦0.1, such as Lu₃Al₅O₁₂:Ce³⁺ and Y₃Al₅O₁₂:Ce³⁺ which emit light in the yellow-green range; and (Sr_{1-x-y}BaₓCa_{y})_{2-z}Si₅₋ₐAlₐN₈₋ₐOₐ:Eu_{z}²⁺ wherein 0≦a≦5, 0<x≦1, 0≦y≦1, and 0<z≦1 such as Sr₂Si₅N₈:Eu²⁺, which emit light in the red range. Suitable Y₃Al₅O₁₂:Ce³⁺ ceramic slabs may be purchased from Baikowski International Corporation of Charlotte, N.C. Other green, yellow, and red emitting phosphors may also be suitable, including (Sr_{1-a-b}Ca_{b}Ba_{c})SiₓN_{y}O_{z}:Euₐ²⁺ (a=0.002-0.2, b=0.0-0.25, c=0.0-0.25, x=1.5-2.5, y=1.5-2.5, z=1.5-2.5) including, for example, SrSi₂N₂O₂:Eu²⁺; (Sr₁₋ᵤ₋ᵥ₋ₓMgᵤCaᵥBaₓ)(Ga_{2-y-z}Al_{y}In_{z}S₄):Eu²⁺ including, for example, SrGa₂S₄:Eu²⁺; Sr₁₋ₓBaₓSiO₄:Eu²⁺; and (Ca₁₋ₓSrₓ)S:Eu²⁺ wherein 0<x≦1 including, for example, CaS:Eu²⁺ and SrS:Eu²⁺.

In one embodiment, the luminescent ceramic is eCAS, which is Ca_{0.99}AlSiN₃:Eu_{0.01} synthesized from 5.436 g Ca₃N₂ (>98% purity), 4.099 g AlN (99%), 4.732 g Si₃N₄ (>98% purity) and 0.176 g Eu₂O₃ (99.99% purity). The powders are mixed by planetary ball milling, and fired for 4 hours at 1500° C. in H₂/N₂ (5/95%) atmosphere. The granulated powder is uniaxially pressed into pellets at 5 kN and cold isostatically pressed (CIP) at 3200 bar. The pellets are sintered at 1600° C. in H₂/N₂ (5/95%) atmosphere for 4 hours. The resulting pellets display a closed porosity and are subsequently hot isostatically pressed at 2000 bar and 1700° C. to obtain dense ceramics with >98% of the theoretical density.

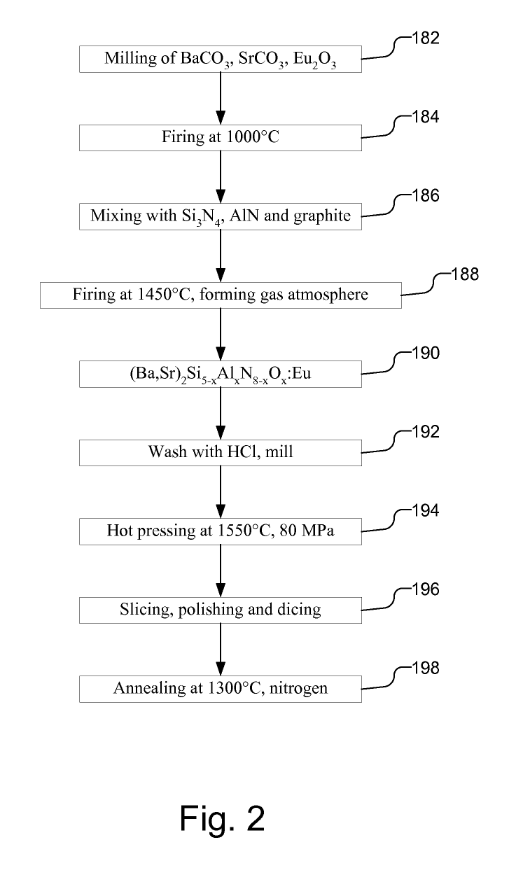

In one embodiment, the luminescent ceramic is BSSNE, which is Ba_{2-x-z}MₓSi_{5-y}Al_{y}N_{8-y}O_{y}:Eu_{z} (M=Sr, Ca; 0≦x≦1, 0≦y≦4, 0.0005≦z≦0.05). The flow diagram depicted in FIG. 2 shows schematically how Ba_{2-x-z}MₓSi_{5-y}Al_{y}N_{8-y}O_{y}:Eu_{z} (M=Sr, Ca; 0≦x≦1, 0≦y≦4, 0.0005≦z≦0.05) ceramics are prepared. Firstly Ba_{2-x-z}MₓSi_{5-y}Al_{y}N_{8-y}O_{y}:Eu_{z} (M=Sr, Ca; 0≦x≦1, 0≦y≦4, 0.0005≦z≦0.05) is prepared in powder form. Several methods can be applied for this purpose. FIG. 2 illustrates an example of the preparation by carbothermal reduction, which includes mixing 60 g BaCO₃, 11.221 g SrCO₃ and 1.672 g Eu₂O₃ (all 99.99% purity) by planetary ball milling using 2-propanol as dispersing agent (block 182). After drying the mixture is fired in forming gas atmosphere at 1000° C. for 4 hours (block 184) and 10 g of the thus obtained Ba_{0.8}Sr_{0.2}:Eu (2%) are mixed with 5.846 g Si₃N₄ (>98% purity), 0.056 g AlN (99% purity) and 1.060 g graphite (microcrystal grade) (block 186). The powders are thoroughly mixed by 20 min. planetary ball milling and fired for 4 hours at 1450° C. in forming gas atmosphere (block 188) to obtain a precursor powder of Ba_{2-x-z}MₓSi_{5-y}Al_{y}N_{8-y}O_{y}:Eu_{z} (M=Sr, Ca; 0≦x≦1, 0≦y≦4, 0.0005≦z≦0.05) (block 190). The powder is washed with HCl and milled again (block 192). The obtained precursor powder is then hot pressed at 1550° C. and 80 MPa yielding dense ceramic bodies (block 194). These are sliced, polished and diced to obtain the desired shape and optical surface properties (block 196). If necessary annealing at 1300° C. in nitrogen can be applied to remove defects (block 198).

In one embodiment, the luminescent ceramic is SSONE, which is manufactured by mixing 80.36 g SrCO₃ (99.99% purity), 20.0 g SiN_{4/3} (>98% purity) and 2.28 g Eu₂O₃ (99.99% purity) and firing at 1200° C. for 4 hour in a N₂/H₂ (93/7) atmosphere. After washing, the precursor powder is uniaxially pressed at 10 kN and subsequently cold isostatic pressed at 3200 bar. Sintering is typically done at temperatures between 1550° C. and 1580° C. under H₂/N₂ (5/95) or pure nitrogen atmosphere.

Referring back to FIG. 1, in one embodiment, the input side 111 of the wavelength converting element 110 is directly covered with a color separation element 116. The color separation element 116 transmits the blue pump light and reflects the wavelengths in the range of the light converted by the wavelength converting element 110. The color separation element 116 may be a high angular acceptance coating that is directly applied to the input side 111 of the wavelength converting element 110, which is facing the light source 102. In other words, the color separation element 116 is between the light source 102 and the wavelength converting element 110. As illustrated in FIG. 1, both the color separation element 116 and the wavelength converting element 110 are physically separated from the light source 102.

The color separation element 116 may be, for example, a directly-applied dichroic coating with the high angular acceptance. If desired, other color separation material may be used, such as a cholesteric film, a diffractive or holographic filter, particularly where the angular emission of the light source 102 is reduced such as from an LED including a photonic crystal. FIG. 3 illustrates the transmission characteristics as a function of wavelength for different angles of incidence for one suitable embodiment of a directly applied dichroic coating that may be used as the color separation element 116. Filters with a high angular acceptance can be designed specifically for this purpose. For example, a dichroic coating may be formed on the wavelength converting element 110 using a stack of multiple layers of higher and lower refractive materials. Typically, a filter is desired with a high angular acceptance by appropriately choosing different coating materials with higher refractive indices and optimized thicknesses. The design and manufacture of such a filter is well within the abilities of those with ordinary skill in the art. The use of a high angular acceptance dichroic coating for the color separation element 116 is advantageous because it eliminates the need for an extra optical element to collimate the light prior to the color separation element 116, thereby reducing the cost and dimensions of the device.

As can be seen in FIG. 3, the color separation element 116 has a high transmission of blue pump wavelengths, e.g., from 415 nm to 465 nm. Thus, the light emitted by light source 102 will be transmitted through the color separation element 116 into the wavelength converting element 110. The wavelength converting element 110 internally emits light isotropically. The forward emitted light, i.e., the light emitted towards the output side 112 of the wavelength converting element 110, has a chance to escape directly. However, a large portion of the light emitted by the wavelength converting element 110 will be either back emitted, i.e., emitted in the direction of the input side 111, or will be forward emitted but will be reflected backwards at the output side 112 of the wavelength converting element 110 due to total internal reflection (TIR) following from the large difference in the index of refraction between the wavelength converting element 110, e.g., n=1.7-2.6, and the medium into which the light is emitted, for example, n=1.0 for air. As can be seen in FIG. 3, the color separation element 116 has a low transmission, i.e., high reflectance, in the wavelengths of the converted light, e.g., wavelengths greater than 500 nm. Thus, the color separation element 116 prevents the back emitted or back reflected light from escaping from the wavelength converting element 110 towards the light source 102.

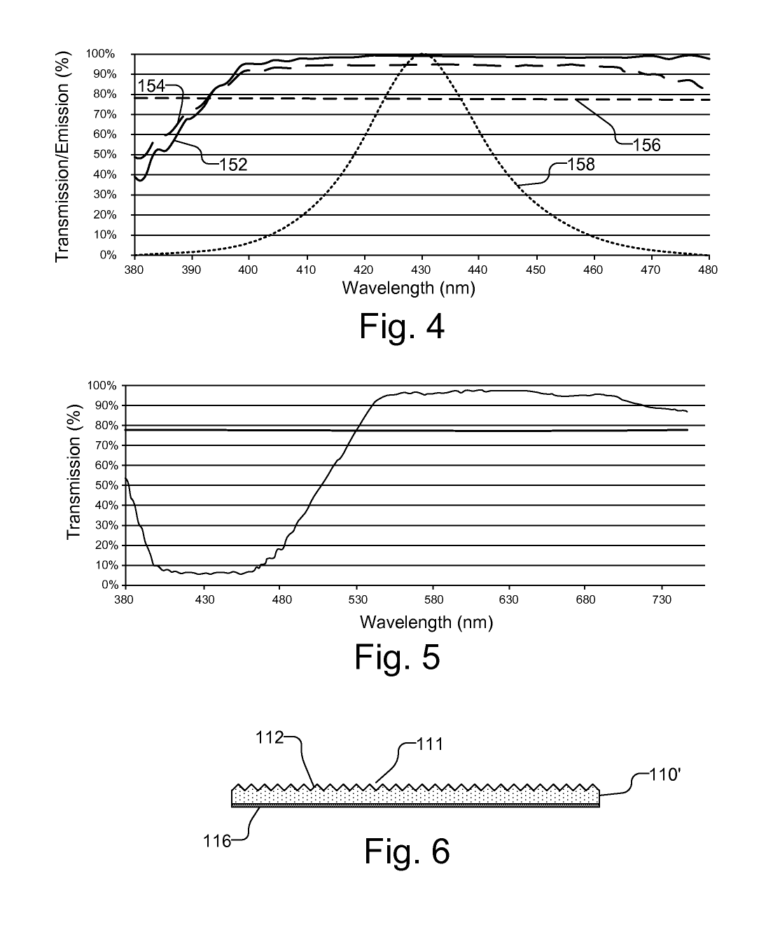

As discussed above, two important criteria for the performance of the illumination device 100 includes the transmission of the blue pump wavelengths, e.g., anywhere from 415 nm to 465 nm, and the reflection of the wavelength converted light, e.g., orange, green, or red converted light. FIG. 4 illustrates the performance of one suitable embodiment of the color separation element 116 with regard to the transmission of the blue pump light as a function of wavelength for a Lambertian source. For reference purposes, FIG. 4 shows transmission curves 152 and 154 for both a 60° Lambertian and a full hemisphere (±90°) Lambertian, respectively. For sake of comparison, the transmission of a bare luminescent ceramic is shown as curve 156, while the spectra of the Blue pump light is illustrated as curve 158. While a cone smaller than 60° may be interesting, e.g., where a photonic lattice structure emits more light in a smaller cone angle, FIG. 4 shows that even at ±90°, the transmission performance can still be significantly better than a high refractive index uncoated luminescent ceramic. As can be seen in FIG. 4, the wavelengths that are efficiently transmitted through the color separation element 116 should cover a large range so that a range of blue pump wavelengths can be accommodated, which reduces the need to sort or bin the light emitting diodes 104 by wavelength, particularly when the absorption spectra of the wavelength converting element 110 is similarly broad.

Referring back to FIG. 1, it should be understood that depending on the thickness and concentration of wavelength converting material in the wavelength converting element 110, not all blue pump light may be converted. The unconverted blue pump light may be permitted to escape through the output side 112 of the wavelength converting element 110. In one embodiment, however, a second color separation element 118 is used to reflect the unconverted blue pump light back into the wavelength converting element. As shown in FIG. 1, the output side 112 of the wavelength converting element 110 may be directly coated with a dichroic filter to serve as the second color separation element 118. FIG. 5 illustrates the transmission characteristics as a function of wavelength as an average of the different angles of incidence for one suitable embodiment of the dichroic coating that serves as the second color separation element 118. As illustrated in FIG. 5, the second color separation element 118 is configured to reflect most of the blue light and transmit the orange/red converted light in this example. As discussed above, the production of an adequate color separation element 118 that produces the desired transmission characteristics is well within the knowledge of those skilled in the art. It should be understood, however, that the second color separation element 118 need not be used if desired.

In addition, if desired, the sides 120 of the wavelength converting element 110 may be coated with a protected reflecting coating 122, such as silver or aluminum, or with a sol-gel or silicone solution with TiO₂ particles, to reflect any light that hits the sides 120 back into the wavelength converting element 110 for improved extraction efficiency. The sides 120 may also be roughened to scatter the reflected light. In another embodiment, the light within the wavelength converting element 110 can be scattered by internal scattering regions, such as intentional holes or micro-cavities in the wavelength converting element 110 causing MIE scattering within the wavelength converting element 110. In some embodiments, the sides 120 of the wavelength converting element 110 may be angled such that the input side 111 and the output side 112 of the wavelength converting element have different areas. For example, the sides may be angled outward so that the input side of wavelength converting element 110 has a smaller area than the output side. Conversely, the sides may be angled inward so that the input side 111 of the wavelength converting element 110 has a larger area than the output side 112. The optimum angle of the sides (either inwards or outwards) depends on the application as it can increase or decrease the emitting surface area and thereby increase or decrease the brightness of the source.

In another embodiment, the output side 112 of the wavelength converting element 110 may have a roughened surface to enhance the light extraction at the output side of the wavelength converting element. FIG. 6, by way of example, illustrates an embodiment of a wavelength converting element 110′ with a color separation element 116 on the input side 111 of the wavelength converting element 110′ and the output side 112′ is a roughened surface. Roughening the surface of the output side 112 of the wavelength converting element 110′ may be performed using well-known processing methods, such as wet chemical etching, dry chemical and related techniques.

As illustrated in FIG. 1, the wavelength converting element 110 may be thermally coupled to and held by one or more sides 120 by a heat sink 130 to provide compact, low cost cooling. A portion, i.e., less than approximately 30%, of either the output side 112 or the input side 111 (or both) of the wavelength converting element 110 may also be in contact with the heat sink 130, e.g., for stability. Thus, the input area of the wavelength converting element 110, i.e., the area of the input side 111 that receives light from the light source 102, and the output area of the wavelength converting element 110, i.e., the area of the output side 112 from which light is externally emitted from the wavelength converting element 110, are unsupported by the heat sink 130. In some embodiments, the reflecting coating 122 may also be deposited on the portion of the output side 112 (or the input side 111) that is covered with the heat sink 130 to assist in recycling. Alternatively, the reflecting coating 122 may be deposited on the heat sink 130 or may be part of the heat sink 130 itself, e.g., where the heat sink 130 is manufactured from a reflective material. The heat sink 130 and/or the reflecting coating 122 on the output side 112 of the wavelength converting element 110 may be used to control the output area and thereby the system etendue. The luminescent ceramic slab that may serve as the wavelength converting element 110 can be easily supported by the sides 120. Moreover, a luminescent ceramic has good thermal conductivity, approximately greater than 10 W/(mK). The use of a heat sink 130 that holds the wavelength converting element 110 only by the at least one side 120 (and possible a small portion of the output side 112 and/or input side 111) is advantageous as it reduces optical losses caused by conventional heat sinks that support wavelength converting elements over the entire output or input side. Moreover, because conventional heat sinks used with wavelength converting elements are produced with sapphire or other similar material, the cost is reduced with heat sink 130.

Further, the heat sink 130 provides the ability to mechanically position the wavelength converting element 110 close to the light source 102 while controlling the temperature of the wavelength converting element 110 to improve efficiency of the wavelength converting element 110. As illustrated in FIG. 1, the heat sink 130 may be coupled to the light source 102 heat sink 106. Alternatively, the heat sink 130 and heat sink 106 may be a single heat sink. Alternatively, the heat sink 130 may be separated from the heat sink 106. Additionally, the heat sink 130 may include cooling elements such as fins 131. Other cooling or heat transfer elements may be used if desired, such as heat pipes.

The heat sink 130 may be produced, e.g., using copper or other conductive material, such as aluminum or graphite. Copper, by way of example, has a high thermal conductivity of approximately 390 W/(mK). The thermal conductivity of graphite in the basal plane (>1000 W/(mK)) is much higher than the thermal conductivity of graphite across the basal plane (<100 W/(mK)). Thus, a heat sink 130 manufactured with graphite should be oriented with the basal plane directed away from the wavelength converting element 110.

As illustrated in FIG. 1, the illumination device 100 may also include reflecting optics 140 that may be used for collimating and/or recycling the light. Reflecting optics 140 are similar to that described in U.S. Pat. No. 7,234,820, Titled “Illuminators Using Reflective Optics With Recycling and Color Mixing”, by Gerard Harbers et al., filed Apr. 11, 2005, which has the same assignee as the present disclosure and the entirety of which is incorporated herein by reference. Reflecting optics 140 includes a side portion 142 that forms, e.g., a parabolic reflector for collimating the light emitted by the light source 102 through the entrance of the reflecting optics 140, which is optically coupled to the output side 112 of the wavelength converting element 110. The side portion 142 may have shapes other than parabolic if desired. The reflector will typically have a circular or rectangular cross-section. The parabolic reflector side portion 142 is made of or coated with a reflective material, such as aluminum, silver, or 3M ESR reflective film or any other appropriate reflective material. Alternatively, the reflecting optics 140 may be a solid transparent material, such as plastic or glass, uses total internal reflection (TIR) caused by the difference between refraction indices of material and air to reflect and collimate the light.

The reflecting optics 140 may also include a reflective aperture, which is formed from a reflective disk 144 that defines an exit in the form of opening 146. The reflective disk 144 may be integral to the reflecting optics 140 or may be a separate piece that is coupled to the reflecting optics 140. The opening 146 may be circular, square or any other desired shape. Any light that is not directed through the opening 146 is reflected back into the reflecting optics 140. The reflected light is then eventually re-reflected towards the opening 146 to create a concentrated collimated light beam. The opening 146 may include a polarizing mirror (not shown) so that light having only a certain polarization state is transmitted while light with other polarization states is reflected back into the reflecting optics 140.

In accordance with embodiments of the invention, collimating optics are formed over and close to the light source. For example, in some embodiments, the collimating optics are formed over the wavelength converting elements shown in FIG. 1, as described in the examples below. In other embodiments, the collimating optics may be formed on a non-wavelength converting structure such as a non-wavelength-converting ceramic, or a glass or sapphire plate. In embodiments where the collimating optics are formed on a non-wavelength-converting structure, scattering regions such as holes in the non-wavelength converting structure may be added where desired, to influence light recycling and randomization. The structure on which the collimating optics are mounted generally spaces the collimating optics between 50 and 500 μm from the surface of the light source (i.e. the light emitting diode). The space can be hollow, or occupied by, for example, a wavelength converting layer or a non-converting element. The distance between the collimating optics and the surface of the light source may be larger than 500 μm, but at least 50 μm of space is desired in order for the light to be sufficiently mixed. The sides of the structure of which the collimating optics are mounted may be reflective, to avoid loss of light from the sides.

In some embodiments, the wavelength converting element is attached to the light source, rather than to a heat sink as illustrated in FIG. 1 and described in accompanying text. In these embodiments, color separation element 116 of FIG. 1 is generally omitted, and as a result some light may be back-reflected into light source 102, but with a highly reflective LED or other light source reflection, this can still lead to an efficient recycling cavity for luminance enhancement.

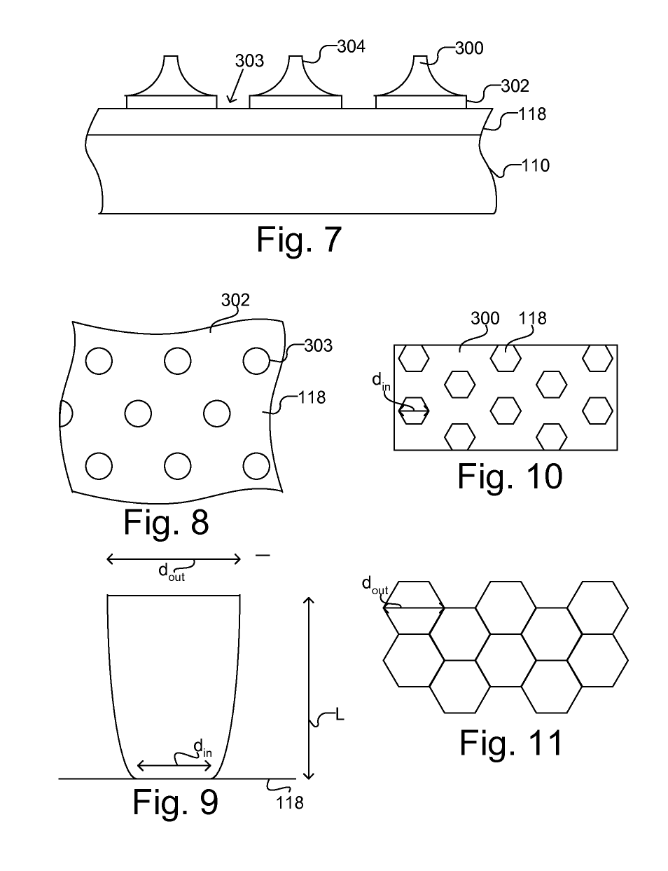

FIG. 7 illustrates a portion of a wavelength converting member 110 from FIG. 1. An optional color separation element 118 is formed on the side of the wavelength converting member from which light exits the wavelength converting member. An array of collimating optics 300 is formed over the wavelength converting member. If present, the optional color separation element is disposed between the wavelength converting member and collimating optics 300. Since color separation element 118 is generally a thin layer, collimating optics 300 are generally within 0.4 to 100 μm of the top surface of the wavelength converting member.

Collimating optics 300 may collimate the light into a cone between, for example 20 and 60° from a normal to the surface on which collimating optics 300 are formed. Examples of suitable collimating optics 300 include hollow reflectors and solid molded collimators, formed from, for example, glass or plastic. Dielectric collimators, which direct light by total internal reflection, may be formed from a single material. The collimating optics 300 shown in FIG. 7 have sidewalls 304 curved to collimate the light exiting the wavelength converting member. An array of collimating optics 300 may be formed on the wavelength converting member, for example by attaching the collimating optics to the wavelength converting member by an adhesive, or as a separate structure that is disposed over the wavelength converting member.

FIG. 8 is a view of a portion of a plane where light enters the collimating optics, i.e. where the collimating optics join the wavelength converting member. The collimating optics are formed proximate to optional color separation element 118, which is disposed over wavelength converting member 110. Openings 303 allow light to escape into the collimating optics. The remaining area 302 reflects light back into wavelength converting member 110. Each collimating optic may be round, as illustrated in FIG. 8, though other shapes are possible. Hexagonal collimating optics are illustrated in FIGS. 10 and 11. FIG. 10 is a view of the plane where light enters hexagonal collimating optics. FIG. 11 is a view of the plane where light exits hexagonal collimating optics. Collimating optics 300 may be arranged in any suitable arrangement; including, for example, the triangular lattice shown in FIG. 8.

In some embodiments, the bottom surface of collimating optics 300 is reflective. In some embodiments, an optional reflective material 302 shown in FIG. 7 is positioned between each collimating optic 300 and the wavelength converting member. Examples of suitable reflective materials include aluminum, silver, dichroic coatings, aluminum combined with a dichroic coating to enhance the reflectivity of the aluminum, and materials such as oxides of titanium and oxides of aluminum suspended in, for example, a sol gel or silicone solution. Each piece of optional reflective material 302 may be the same size and shape as the bottom of a collimating optic 300, as illustrated in FIG. 7, though they need not be. In some embodiments, reflective material 302 is smaller than the bottom of collimating optic 300.

The performance of a collimating optic is a function of the optical shape and the ability for the geometry to be relatively close to etendue-conserving, like a compound parabolic concentrator shape. In such case, the performance of the optic is also a function of the width of the collimator in the plane where light enters the collimator dᵢₙ, the width of the collimator in the plane where light exits the collimator dₒᵤₜ, and the height of the collimator L, as illustrated in FIG. 9. The height, width, and spacing of collimating optics 300 are a function of the collimation angle, and the refractive index of the collimator material n. For an air cavity with reflective sidewalls the refractive index n is n=1, while for a dielectric concentrator the refractive index n may be, for example, n=1.5. The relationship between the width dₒᵤₜ and dᵢₙ of the air type collimator for a target maximum half cone angle Angleₘₐₓ is in first order given by: dₒᵤₜ/dᵢₙ=1/(sin(Angleₘₐₓ). The height of the collimating optic L is given by: L=(dₒᵤₜ+dᵢₙ)/(2*tan(Angleₘₐₓ)). Non-etendue conserving optical shapes may have collimation angles, optical height, and area ratios larger than those described by the formulas herein.

For a collimation angle of Angleₘₐₓ this results in a relationship where for etendue conserving optics, the collimator input area Aᵢₙ (the area of the opening in the collimating optic at width dᵢₙ) versus the collimator output area Aₒᵤₜ (the area of the opening in the collimating optic at width dₒᵤₜ) can be calculated by Aᵢₙ=Aₒᵤₜ*(sin(Angleₘₐₓ))². In an embodiment with a target collimation angle of 45°, the input area of the collimators is approximately 50% of the output area. The remaining 50% of the surface of the wavelength converting element is blocked by the collimating optics (area 302 in FIG. 8, in a device with a separate reflective element 302 between the collimating optics and the wavelength converting element, and area 300 in FIG. 10, in a device without a separate reflective element 302). Light incident on the collimating optics in this area is reflected back into the wavelength converting element, where it has multiple chances to escape into an opening for collimation. The output side of the collimating optics has approximately the same area as the total area of the reflective surface and the openings in the collimating optics.

The choice between a hollow and an optically attached solid collimator is often a choice between the extraction gain from the dielectric material and the recycling efficiency of the optical cavity, as using a collimator with a refractive index of n results, for a given collimation angle, in n² less collimator input surface area as compared to a hollow air collimator. A solid collimator may also not be in optical contact with the surface on which it is mounted; that is, there may be an air space between the collimators and the surface on which they are mounted, in which case the n² factor does not apply.

As described above, in some embodiments the target maximum half cone angle Angleₘₐₓ is between 20 and 60°. The width dₒᵤₜ of each collimating optic where light exits the optic may be between 0.1 and 3 mm. The height L of each collimating optic may be less than 3 mm.

In some embodiments, reflective regions 302 may be configured as heat sinks, to disperse heat from the wavelength converting member. Additional heat sinking provided by reflective regions 302 is particularly useful in high power systems, where a significant portion of the light emitted by the light source is absorbed in the wavelength converting element. As a result, heat may build up in the wavelength converting element. In contrast to conventional heat sinks which may absorb light, reflective region 302 reflect light back toward the light source for recycling. In some embodiments, thermally conductive bars may connect individual reflective regions 302 and extend beyond the wavelength converting element for heat removal.

Having described the invention in detail, those skilled in the art will appreciate that, given the present disclosure, modifications may be made to the invention without departing from the spirit of the inventive concept described herein. Therefore, it is not intended that the scope of the invention be limited to the specific embodiments illustrated and described.

What is being claimed is:

1. A structure comprising:
a light source configured to emit light having a first peak wavelength; and
a plurality of members positioned over the light source in a path of light emitted from the light source, wherein each of the plurality of members is configured to direct at least a portion of light exiting the light source in a direction substantially perpendicular to a top surface of the light source.

2. The structure of claim 1 wherein the plurality of members are disposed within between 50 and 500 μm of a top surface of the light source.

3. The structure of claim 1 wherein the light source includes at least one III-nitride light emitting diode.

4. The structure of claim 1 further comprising plate disposed between the plurality of members and the light source.

5. The structure of claim 4 wherein the plurality of members are disposed on the plate, wherein at an interface between the plate and the plurality of members, a first area of the interface is transparent, and a second area of the interface is reflective.

6. The structure of claim 4 wherein the plate is one of glass, ceramic and Al₂O₃.

7. The structure of claim 1 further comprising a wavelength converting element disposed between the plurality of members and the light source, the wavelength converting element configured to absorb at least a portion of the light having a first peak wavelength and emit light having a second peak wavelength.

8. The structure of claim 7 wherein the plurality of members are attached to the wavelength converting element.

9. The structure of claim 7 wherein the wavelength converting element comprises a ceramic phosphor.

10. The structure of claim 1 wherein each of the plurality of members have a curved sidewall.

11. The structure of claim 1 wherein a bottom surface of each of the plurality of members is reflective.

12. The structure of claim 1 further comprising a reflective material disposed between a portion of each member and the light source.

13. The structure of claim 12 wherein regions of reflective material are connected to form a heat sink.

14. A structure comprising:
a light source emitting light having a first wavelength range;
a wavelength converting element that receives the emitted light from the light source, the wavelength converting element at least partially converting the emitted light having a first wavelength range into light having a second wavelength range; and
a plurality of members disposed proximate the wavelength converting member, such that the wavelength converting element is disposed between the members and the light source, wherein each of the plurality of members comprises a reflective sidewall configured to direct at least a portion of light exiting the wavelength converting element in a direction substantially perpendicular to a top surface of the wavelength converting element.

15. The structure of claim 14 further comprising a heat sink thermally holding the wavelength converting element so that the wavelength converting element is not in direct contact with the light source, the heat sink holding the wavelength converting element by at least one side of the wavelength converting element so that neither an input area of the wavelength converting element that receives the emitted light from the light source nor an output area of the wavelength converting element from which the light having a second wavelength range is emitted by the wavelength converting element are supported by the heat sink.

16. The structure of claim 15 wherein the light source is thermally coupled to the heat sink.

17. The structure of claim 14 further comprising a color separation element disposed between the plurality of members and the wavelength converting element.

18. The structure of claim 14 further comprising a color separation element disposed between the wavelength converting element and the light source.

19. A structure comprising:
a light source configured to emit light having a first peak wavelength;
a wavelength converting element positioned in a path of light emitted from the light source, the wavelength converting element configured to absorb at least a portion of the light having a first peak wavelength and emit light having a second peak wavelength; and
a plurality of collimating optics positioned such that the wavelength converting element is disposed between the plurality of collimating optics and the light source, wherein a bottom of each of the plurality of collimating optics comprises an opening and a reflective portion.

20. The structure of claim 19 wherein a total area of the openings is less than 50% of an area of a top surface of the wavelength converting element.

21. The structure of claim 19 wherein a total area of the reflective portions is less than 50% of an area of a top surface of the wavelength converting element.

22. The structure of claim 19 wherein the plurality of collimating optics collimate light emitted by the light source into a maximum half cone angle between 20 and 60°.

23. The structure of claim 19 wherein each collimating optic is less than 3 mm tall.
